(19) United States
(12) Patent Application Publication
(10) Pub. No.: US 2026/0349297 A1
(43) Pub. Date: Nov. 5, 2026

(54) LENTICULAR DISPLAY WITH TOUCH SENSOR

(71) Applicant: GOOGLE LLC, Mountain View, CA (US)

(72) Inventors: Paulo Irulegui, Palo Alto, CA (US); John D. Perreault, Mountain View, CA (US)

(21) Appl. No.: 19/667,102

(22) Filed: May 4, 2026

Related U.S. Application Data
(60) Provisional application No. 63/799,966, filed on May 5, 2025.

(51) Int. Cl. G02F 1/1333; G02F 1/1335; G06F 3/044

(52) U.S. Cl. CPC G02F 1/13338; G02F 1/133526; G02F 1/133528; G06F 3/0445

(57) ABSTRACT

An apparatus includes a display cell, a lenticular lens, a first touch sensor layer disposed between the display cell and a substrate, and a second touch sensor layer. The substrate is disposed between the first touch sensor layer and the second touch sensor layer. The second touch sensor layer is disposed between the substrate and the lenticular lens.

### CROSS-REFERENCE TO RELATED APPLICATION

This application claims priority to U.S. Provisional Application No. 63/799,966, filed May 5, 2025, entitled “LENTICULAR DISPLAY WITH TOUCH SENSOR “, the disclosure of which is incorporated by reference herein in its entirety.

### TECHNICAL FIELD

This description relates to lenticular displays with touch sensors.

### BACKGROUND

Touch sensors, such as capacitive sensors, can refract light. In a lenticular display, the inclusion of a touch sensor can reduce the image quality that is provided to eyes.

### SUMMARY

A lenticular display includes a touch sensor. To reduce the loss of image quality, the touch sensor is disposed close to a display cell that produces the image.

According to an example, an apparatus includes a display cell, a lenticular lens, a first touch sensor layer disposed between the display cell and a substrate, and a second touch sensor layer. The substrate is disposed between the first touch sensor layer and the second touch sensor layer. The second touch sensor layer is disposed between the substrate and the lenticular lens.

According to an example, an apparatus includes a display cell, a first lenticular glass layer, a substrate disposed between the display cell and the first lenticular glass layer, the first lenticular glass layer disposed between the substrate and a first touch sensor layer, the first touch sensor layer disposed between the first lenticular glass layer and a liquid crystal layer, the liquid crystal layer disposed between the first touch sensor layer and a second touch sensor layer, the second touch sensor layer between the liquid crystal layer and a second lenticular glass layer, and the second lenticular glass layer.

According to an example, an apparatus includes a first touch sensor layer, a substrate disposed between the first touch sensor layer and a second touch sensor layer, the second touch sensor layer disposed between the substrate and a display cell, the display cell disposed between the second touch sensor layer and a lenticular stack, and the lenticular stack.

The details of one or more implementations are set forth in the accompanying drawings and the description below. Other features will be apparent from the description and drawings, and from the claims.

### BRIEF DESCRIPTION OF THE DRAWINGS

FIG. 1 shows a user holding a computing device with a lenticular display and touch sensor.

FIG. 2 is an example of a lenticular display with a touch sensor.

FIG. 3 is another example of a lenticular display with a touch sensor.

FIG. 4 is another example of a lenticular display with a touch sensor.

FIG. 5 is another example of a lenticular display with a touch sensor.

FIG. 6 is another example of a lenticular display with a touch sensor.

FIG. 7 is an example of a touch sensor.

FIG. 8 shows an example of a screen and lenticular lens that can be included in a lenticular display.

### DETAILED DESCRIPTION

The technology described herein improves screens that display three-dimensional (3D) images while also acting as touchscreens, such as those found on smartphones, tablets, or laptops. Adding a touch sensor to a 3D screen can cause the image to blur, because the materials in the touch sensor scatter the light as it travels toward the eyes of the user. To reduce blurring, the touch sensor is embedded deeper inside the layers of the screen, placing the touch sensor close to the display cells that generate the image. In some implementations, the touch sensor is implemented as a capacitive touch sensor or a projective capacitive touch sensor. Use of a capacitive touch sensor or a projective capacitive touch sensor can provide touch-input capability at lower cost than an infrared touch sensor while preserving a desired form factor of the computing device. Because the touch sensor is closer to the image source, the light has less distance to travel and spread before contacting the outer lenses, which maintains sharpness and clarity of the 3D image while still accurately registering the physical touch inputs of the user.

A technical problem with including a touch sensor in a lenticular display is that some touch sensors can scatter light and thereby reduce the image quality. Optical inhomogeneities in the touch sensor can scatter the light. Light directed to one eye can be received by the other eye, causing the image to blur. The farther the touch sensor is from the source of light, the more scattering occurs and the more the image seen by the user is blurred. With capacitive touch sensors and projective capacitive touch sensors, one or more transparent conductive touch sensor layers may be positioned in the optical path through which image light travels from the display cell toward the lenticular optics. An infrared touch sensor can use emitters and receivers positioned around a perimeter of an active display area and may avoid placing a touch-sensing layer in the optical path, but at increased cost or bezel complexity. A technical solution to this technical problem is to include the touch sensor close to the pixels that generate the image. A technical benefit of this technical solution is improved image quality in a lenticular display that includes a touch sensor.

In some implementations, a touch sensor can be close to the display cell by the touch sensor being directly adjacent to the display cell or being separated from the display cell by one or more optically clear intermediate layers, such as an adhesive layer, a polarizer, or a protective glass layer, while still being positioned physically nearer to the display cell than to the lenticular lens. In some implementations, close placement of the touch sensor to the display reduces a propagation distance over which light redirected by the touch sensor can laterally deviate before reaching the lenticular optics.

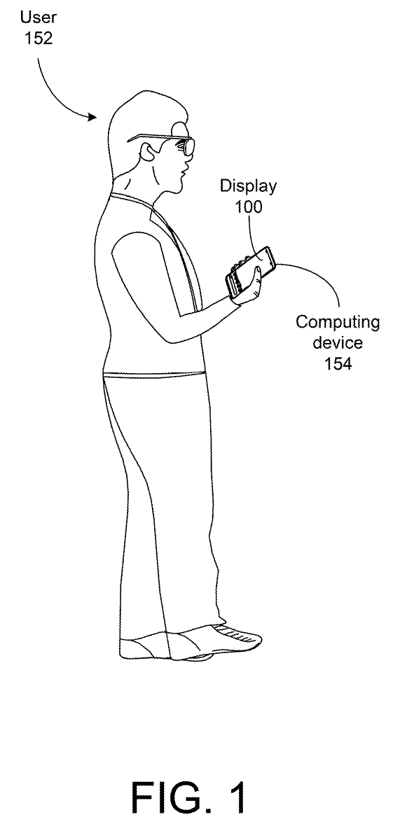

FIG. 1 shows a user 152 holding a computing device 154 with a lenticular display 100 and touch sensor. In the example shown in FIG. 1, the computing device 154 is a smartphone. However, the computing device 154 can also be a tablet computing device, laptop or notebook computing device, phablet, or any other computing device with a display that receives and processes touch input.

The lenticular display 100 presents three-dimensional images to the user 152. The lenticular display 100 presents three-dimensional images to the user 152 by sending different images to a left eye of the user 152 and a right eye of the user 152. As used herein, “lenticular” can refer to an optical structure including one or more lens features configured to refract light from a display at different angles so that different images are directed to different viewing positions. A lenticular element can include, as non-limiting examples, a lenticular lens, a lenticular layer, or a lenticular stack including such a lens. In some implementations, the lenticular optical structure cooperates with a display cell to provide autostereoscopic viewing, including presentation of different images to a left eye and a right eye of a user to create an impression of a three-dimensional image.

The lenticular display 100 receives touch input from the user 152. The lenticular display 100 receives touch input from the user 152 by the user 152 touching the lenticular display 100, such as with a finger of the user 152, or by the user 152 placing a finger or stylus in proximity to a touch-sensitive surface of the lenticular display 100. The computing device 154 can process the touch input. In some implementations, the lenticular display 100 includes one or more resistive layers that process the touch input. In some implementations, the lenticular display 100 includes one or more conductive layers that process the touch input. In some implementations, the lenticular display 100 includes glass or plastic layers. The layers can include coatings, such as Indium Tin Oxide (ITO) coatings, which form a network of resistors that change resistance and/or conductance in response to pressure from touch. In some implementations, the lenticular display 100 includes an infrared bezel with infrared emitters and infrared receivers that process touch input. In some implementations, the lenticular display 100 includes capacitive in-cell traces in an inner surface of the lenticular display 100 that process the touch input. In some implementations, the lenticular display 100 includes one or more capacitive surfaces with electrodes along a perimeter of the lenticular display 100 that process touch input. In some implementations, the lenticular display 100 includes one or more projective capacitive layers that process touch input. A projective capacitive layer can include one or more projective capacitive touch sensors. A projective capacitive touch sensor can be a capacitive touch sensor configured to detect a touch or proximity input through a dielectric layer, such as a glass layer, so that the input can be registered when a finger or stylus contacts the dielectric layer or is spaced slightly away from an underlying touch sensor layer. The projective capacitive layers can include transparent conductive coatings, such as indium tin oxide (ITO) coatings, that are patterned to form sensing electrodes. In some comparative touch-sensing technologies, an infrared touch sensor includes an infrared bezel with infrared emitters and infrared receivers around an active display area. Such an infrared touch sensor may avoid placing a touch-sensing layer in the optical path through the lenticular display 100, but may increase cost, bezel complexity, or device size relative to a capacitive touch sensor. Touch sensor layers described herein can include resistive layers or capacitive layers.

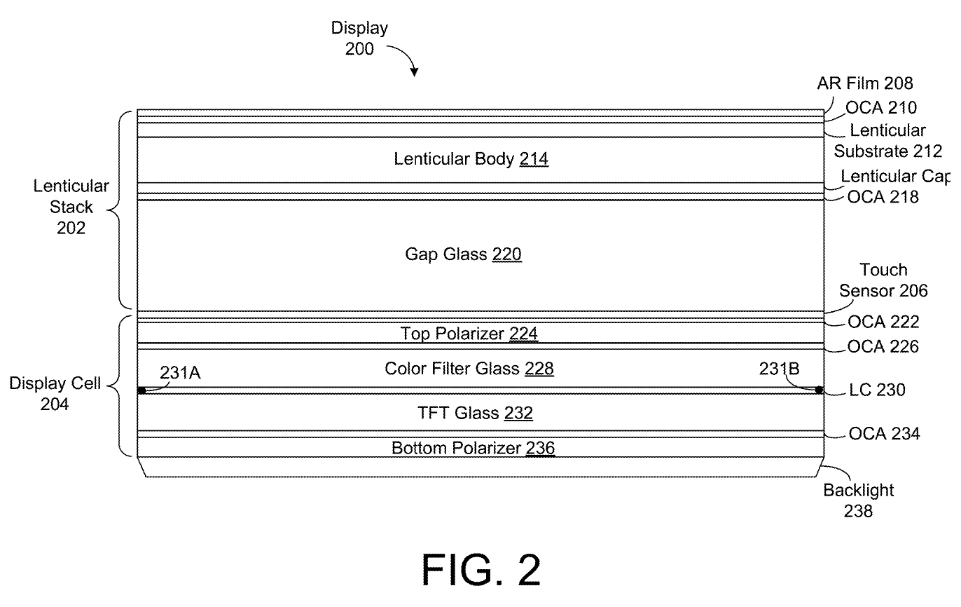

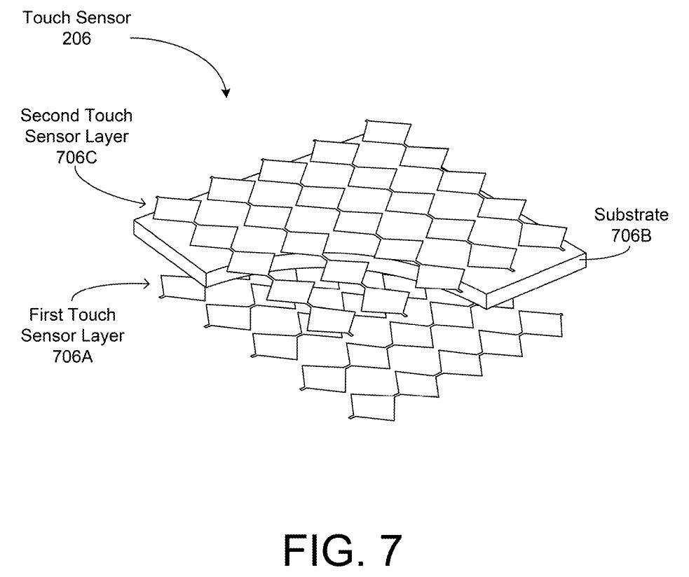

FIG. 2 is an example of a lenticular display 200 with a touch sensor 206. The touch sensor 206 is shown in more detail in FIG. 7. The touch sensor 206 includes a first touch sensor layer 706A, a substrate 706B disposed between the first touch sensor layer 706A and a second touch sensor layer 706C, and the second touch sensor layer 706C. The substrate 706B can include a dielectric substrate.

The lenticular display 200 can include a display cell 204. The display cell 204 can generate light that will be seen by a user, such as the user 152. The lenticular display 200 can include the touch sensor 206 disposed between the display cell 204 and a lenticular lens. In some implementations, the lenticular lens is included in a lenticular stack 202. A lenticular stack can include a lenticular lens and one or more additional layers disposed adjacent to the lenticular lens, including, as non-limiting examples, a gap glass 220, one or more optically-clear adhesives, and a protective film 208. In some implementations, the lenticular stack comprises the lenticular lens. The touch sensor 206 is disposed between the display cell 204 and the lenticular stack 202. The display cell 204 can include the lenticular lens and/or lenticular stack 202. The first touch sensor layer 706A can be disposed between the display cell 204 and the substrate 706B. The substrate 706B can be disposed between the first touch sensor layer 706A and the second touch sensor layer 706C. The second touch sensor layer 706C can be disposed between the substrate 706B and the lenticular lens.

The display cell 204 can be implemented by various display technologies, such as organic light-emitting diodes or liquid crystal displays. In an example in which the display cell is implemented as a liquid crystal display, the display cell 204 caninclude polarizers, such as a first polarizer or bottom polarizer 236 and a second polarizer or top polarizer 224. A polarizer can be an optical layer configured to preferentially transmit light having a selected polarization state and to attenuate light having another polarization state. The bottom polarizer 236 can be disposed between a backlight 238 and the glass (such as TFT glass 232). The backlight 238 can be considered part of the display cell 204 or separate from the display cell 204. The backlight 238 can generate visible light. Some of the visible light generated by the backlight 238 passes through the lenticular display 200 and is seen by the user 152.

In some implementations, the display cell 204 can be implemented by another emissive or transmissive display technology. For example, the display cell 204 can include an organic light-emitting diode display, a micro light-emitting diode display, or another flat-panel display that emits or modulates light for direction by the lenticular optics. In such implementations, layers associated with a liquid crystal display can be omitted, replaced, or modified according to the selected display technology while maintaining placement of the touch sensor 206 within the optical stack.

The bottom polarizer 236 and top polarizer 224 can be layers of light-filtering crystalline material. Each of the bottom polarizer 236 and top polarizer 224 passes a predefined bandwidth, or range of wavelengths, of light, and filters out wavelengths outside of the predefined bandwidth or range of wavelengths. In some implementations, the bottom polarizer 236 and/or top polarizer selectively transmit and/or filter light based on polarization state. In some implementations, the bottom polarizer 236 and/or top polarizer act as color filters and/or spectral filters, passing and/or filtering light of wavelengths inside and/or outside of predefined bandwidth and/or range of wavelengths. The polarizers 236, 224 and liquid crystal layer 230 can act as a light switch by location, allowing or preventing light from passing through at different locations.

The bottom polarizer 236 is disposed between the backlight 238 and a glass layer. In some implementations, a glass layer includes a glass sheet positioned within the optical stack of the lenticular display, including, as non-limiting examples, the gap glass 220, a cover glass, a TFT glass layer 232, and a color filter glass 228. Examples of glass layers are soda lime glass, boro-aluminosilicate glass, and borosilicate glass. The bottom polarizer 236 is disposed between the backlight 238 and a liquid crystal layer 230. The liquid crystal layer 230 can be considered a display liquid crystal layer. The top polarizer 224 is disposed between the glass layer and the touch sensor 206. The top polarizer 224 is disposed between the glass layer and the first touch sensor layer 706A. The top polarizer 224 is disposed between the liquid crystal layer 230 and the touch sensor 206. The top polarizer 224 is disposed between the liquid crystal layer 230 and the first touch sensor layer 706A.

In some implementations, the display cell 204 includes two glass layers. One of the glass layers in the display cell 204 can be a thin-film transistor (TFT) glass layer 232. The TFT glass layer 232 can include transistors grown on glass by thin film deposition. Another of the glass layers in the display cell 204 can be a color filter glass 228. The color filter glass 228 can include a thin glass substrate with red, green, and blue color resist patterns that allow transmission of light in red, green, and blue, respectively. In some implementations, a glass substrate includes a glass layer that provides mechanical support for one or more adjacent layers, including a polarizer, a touch sensor layer, or a lenticular lens layer.

The display cell 204 can include a liquid crystal layer 230 between the TFT glass layer 232 and the color filter glass 228. The liquid crystal layer 230 includes liquid crystals that align in response to an electric field to control the light passing through the liquid crystal layer 230. The alignment of the liquid crystals to control the light creates the image seen by the user 152. The display cell 204 can include one or more electrodes 231A, 231B that control the electric field in the liquid crystal layer 230.One or more electrodes 231A, 231B can be included in the TFT glass layer 232 and/or color filter glass 228 to enable the electric field that controls the liquid crystals.

The display cell 204 can include an optically-clear adhesive (OCA) 234 between the bottom polarizer 236 and the TFT glass layer 232. The OCA 234 can bond the bottom polarizer 236 to the TFT glass layer 232. The OCA 234 can include acrylic-based liquid or silicone, as non-limiting examples. While OCAs are referred to herein, optically clear resin (OCR) can substitute for or replace the OCAs. In some implementations, an OCR can be applied to components that do not include an OCA, such as gap glass and/or a surface of a polarizer such as a top surface of a polarizer. An OCR can be applied and cured with ultraviolet light.

The display cell 204 can include an OCA 226 between the color filter glass 228 and the top polarizer 224. The OCA 226 can bond the color filter glass 228 to the top polarizer 224. The OCA 226 can include acrylic-based liquid or silicone, as non-limiting examples.

The lenticular display 200 can include an OCA 222 between the top polarizer 224 and the touch sensor 206. The OCA 222 can bond the display cell 204 to the touch sensor 206. The OCA 222 can bond the top polarizer 224 to the touch sensor 206. The OCA 222 can bond the top polarizer 224 to the first touch sensor layer 706A. The OCA 222 can include acrylic-based liquid or silicone, as non-limiting examples.

In some implementations, a glass layer is disposed between the display cell 204 and the touch sensor 206. The glass layer can be a cover glass or other protective glass substrate. The glass layer can be bonded to the display cell 204 and to the touch sensor 206 using an optically-clear adhesive, and can provide mechanical protection while maintaining optical quality for the lenticular display.

The lenticular stack 202 can include a gap glass 220 and a lenticular lens. The lenticular lens can include multiple layers of lenses that refract light at different angles. In the example shown in FIG. 2, the lenticular lens includes a lenticular cap 216, a lenticular body 214, and a lenticular substrate 212.

In some implementations, the lenticular lens is manufactured by depositing a resin on a substrate, which becomes the lenticular substrate 212. The resin can be an ultraviolet plastic resin, such as a polyethylene terephthalate (PET) resin. The lenticular body 214 can be manufactured by curing the resin between the lenticular substrate 212 and a roll mold in a roll-to-roll process. The lenticular cap 216 can also be manufactured by depositing a resin, which can be an ultraviolet resin such as PET resin, on the lenticular body in a roll-to-roll process.

The lenticular cap 216 can have a different index of refraction than the lenticular body 214. In some implementations, the index of refraction of the lenticular cap 216 is lower than the index of refraction of the lenticular body. In an example implementation, the index of refraction of the lenticular cap 216 is 1.47 and the index of refraction of the lenticular body 214 is 1.62. The different indices of refraction of the lenticular cap 216 and lenticular body 214 focus light rays at a focal point, focusing the light rays and/or sub-pixel images emitted by the display cell 204 on the eye of the user.

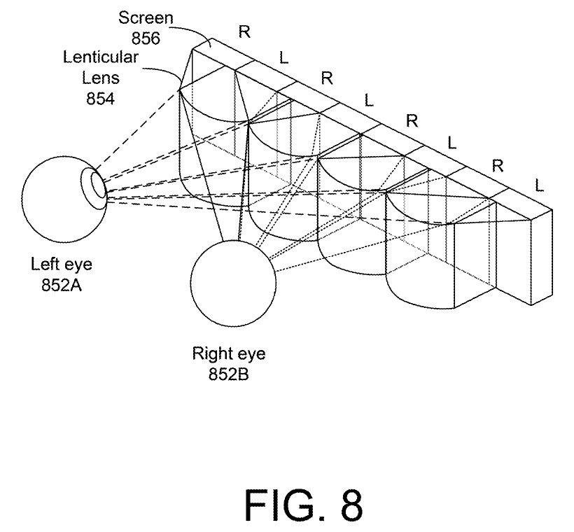

The multiple layers of lenses in the lenticular lens, such as the lenticular cap 216 and the lenticular body 214, can cooperate to refract light to provide different images at different angles, so that a left eye and a right eye of the user 152 will see different images, creating an impression of a three-dimensional image, as shown and described below with respect to FIG. 8. The gap glass 220 can be between the touch sensor 206 and the lenticular lens. The gap glass 220 can be considered a gap glass substrate, which can be a glass layer disposed between a lenticular lens and a display cell to provide spacing, mechanical support, or both within the optical stack.

The lenticular stack 202 can include an OCA 218 between the gap glass 220 and the lenticular lens or lenticular cap 216. The OCA 218 can bond the gap glass 220 to the lenticular lens or lenticular cap 216. The OCA 218 can include acrylic-based liquid or silicone, as non-limiting examples.

In the lenticular lens, the lenticular body 214 is between the lenticular cap 216 and the lenticular substrate 212. The lenticular cap 216 is between the gap glass 220 and the lenticular body 214.

The lenticular display 200 can include a film 208. The film 208 protects the lenticular lens. The lenticular lens can be between the gap glass 220 and the film 208. The lenticular substrate 212 can be between the lenticular body 214 and the film 208. The lenticular display 200 can include an OCA 210 between the lenticular substrate 212 and the film 208. The OCA 210 can bond the lenticular lens and/or lenticular substrate 212 to the film 208. The OCA 210 can include acrylic-based liquid or silicone, as non-limiting examples.

In some implementations, the optically-clear adhesive (OCA) 222, the OCA 218, the OCA 210, the OCA 226, and/or the OCA 234 are selected to reduce optical loss across interfaces of the lenticular display. The OCA can have a refractive index selected to more closely match adjacent layers, thereby reducing Fresnel reflection and visible interface artifacts. The OCA can further be selected to have haze, birefringence, and thickness uniformity characteristics that preserve image quality. In some embodiments, optically clear resin is used in place of one or more OCA layers. A lamination process can be performed under reduced pressure to reduce bubbles and voids, and curing can be performed after alignment of the layers so that a relative position of the display cell 204, the touch sensor 206, and the lenticular stack 202 is maintained.

In some embodiments, the lenticular stack 202 is registered to the display cell 204 such that a pitch of the lenticular lens corresponds to a pitch of repeating pixel groups or sub-pixel groups of the display cell 204. Registration can include lateral alignment, rotational alignment, and control of spacing between the lenticular lens and the display cell 204. Alignment marks can be provided on one or more of the display cell 204, the touch sensor 206, the gap glass 220, or the lenticular substrate 212 to facilitate assembly. In some embodiments, an offset between the lenticular lens and the display cell 204 is compensated electronically by modifying image data written to the display cell 204 so that image views intended for different viewing zones remain aligned with optical output directions of the lenticular lens.

In some implementations, optical degradation introduced by the touch sensor 206 increases as spacing between the touch sensor 206 and the display cell 204 increases. A local refractive-index variation, thickness variation, conductive trace, or surface irregularity in the touch sensor 206 can redirect a portion of light emitted from the display cell 204. As the redirected light propagates across a larger distance before reaching the lenticular stack 202, the redirected light can shift laterally relative to an intended optical path and can enter a viewing zone associated with another eye. By positioning the touch sensor 206 adjacent to the display cell 204, such as adjacent to the top polarizer 224 or within a bonded subassembly of the display cell 204, the distance over which the redirected light propagates before entering the lenticular stack 202 is reduced, thereby reducing crosstalk between left-eye and right-eye image information and improving sharpness of a three-dimensional image.

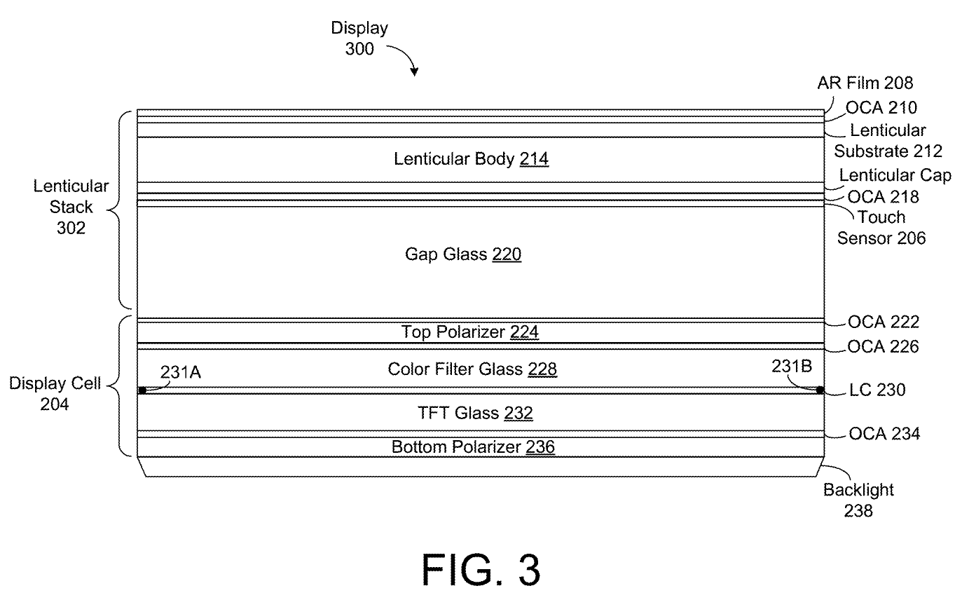

FIG. 3 is another example of a lenticular display 300 with a touch sensor 206. In this example, the touch sensor 206 is disposed between the gap glass 220 and the lenticular lens and/or lenticular cap 216. The touch sensor 206 is bonded to the lenticular lens and/or lenticular cap 216 by the OCA 218. In this example, a lenticular stack 302 included in the lenticular display 300 includes the touch sensor 206 between the gap glass 220 and the lenticular lens and/or between the gap glass 220 and the lenticular cap 216.

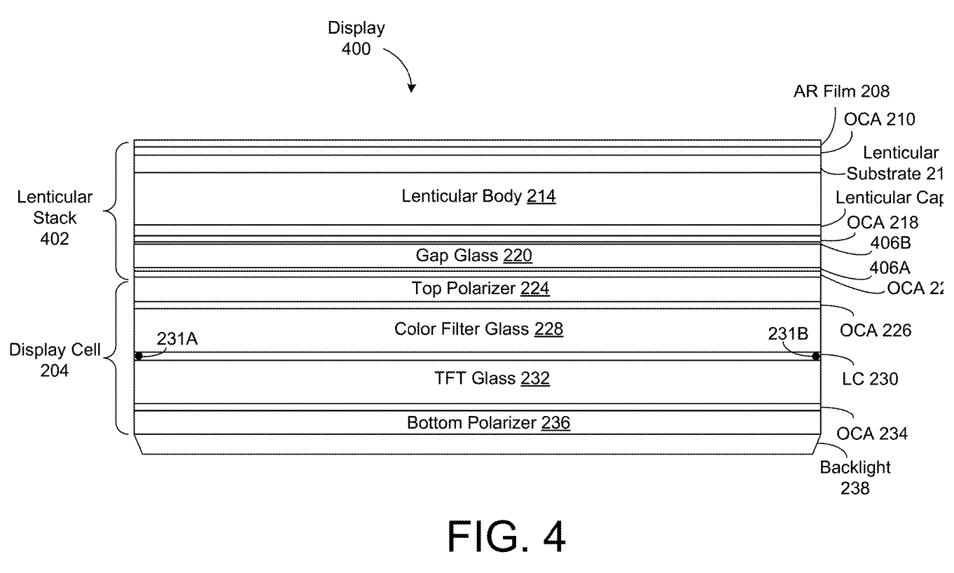

FIG. 4 is another example of a lenticular display 400 with a touch sensor. In this example, a lenticular stack 402 includes the touch sensor between the top polarizer 224 and the lenticular lens and/or lenticular cap 216. In this example, the touch sensor includes a first touch sensor layer 406A, the gap glass 220, and a second touch sensor layer 406B. The first touch sensor layer 406A is disposed between the top polarizer 224 and the gap glass 220. The first touch sensor layer 406A has similar features as the first touch sensor layer 706A. The first touch sensor layer 406A is bonded to the top polarizer 224 by the OCA 222. The gap glass 220 is between the first touch sensor layer 406A and the second touch sensor layer 406B. The second touch sensor layer 406B is between the gap glass 220 and the lenticular lens and/or lenticular cap 216. The second touch sensor layer 406B has similar features as the second touch sensor layer 706C. The second touch sensor layer 406B is bonded to the lenticular lens and/or lenticular cap 216 by the OCA 218.

In some implementations, the position of the touch sensor 206 within the optical stack is selected based on a balance between image quality, manufacturability, touch performance, and structural protection. For example, the arrangement of FIG. 3 can place the touch sensor 206 closer to the lenticular lens while still permitting a relatively compact stack, and the arrangement of FIG. 4 can distribute touch-sensing features on opposite sides of the gap glass 220. Different placements of the touch sensor 206 can be selected to accommodate available adhesive interfaces, desired stack thickness, routing constraints, or compatibility with a selected lenticular lens construction.

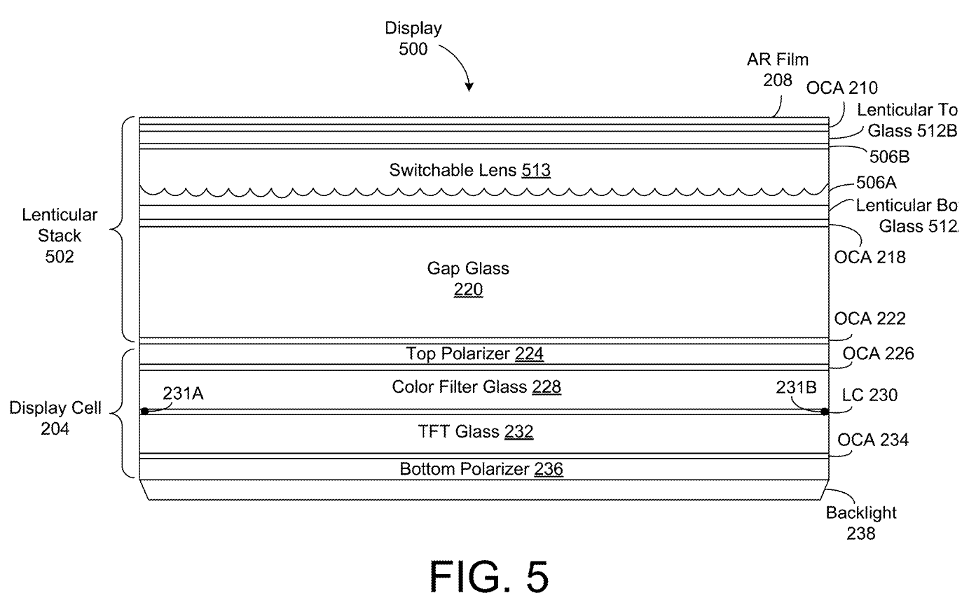

FIG. 5 is another example of a lenticular display 500 with a touch sensor. In this example, a lenticular stack 502 includes the touch sensor between a lenticular bottom glass 512A and a lenticular top glass 512B. In this example, the touch sensor includes a bottom layer or first touch sensor layer 506A and a top layer or second touch sensor layer 506B on either side of a switchable lens layer 513. The switchable lens layer 513 is between the first touch sensor layer 506A and the second touch sensor layer 506B. Touch, such as touch from a finger or stylus, changes capacitance associated with electrodes of the touch sensor layers. Changes to capacitance of the switchable lens layer 513 can be detected by circuitry in the touch sensor layers 506A, 506B to determine a location of the touch. The first touch sensor layer 506A has similar features as the first touch sensor layer 706A. The second touch sensor layer 506B has similar features as the second touch sensor layer 706C.

In the example shown in FIG. 5, the lenticular lens includes a first lenticular layer (or first lenticular glass layer) or lenticular bottom glass 512A, the switchable lens layer 513, and a second lenticular layer (or second lenticular glass layer) or lenticular top glass 512B. The switchable lens layer 513 is between the lenticular bottom glass 512A and the lenticular top glass 512B. The switchable lens layer 513 includes liquid crystals that are controlled by an electric field to change the refraction of light passing through the switchable lens layer 513. In some implementations, the switchable lens layer 513 includes a liquid crystal layer that is controlled by an electric field to change refraction of light passing through the switchable lens layer 513, and such liquid crystal layer can be referred to herein as a liquid crystal layer. The switchable lens layer 513 can be considered a switchable liquid crystal layer. The first touch sensor layer 506A is between the lenticular bottom glass 512A and the switchable lens layer 513. The second touch sensor layer 506B is between the switchable lens layer 513 and the lenticular top glass 512B. The lenticular bottom glass 512A is bonded to the gap glass 220 by the OCA 218. The lenticular top glass 512B is bonded to the film 208 by the OCA 210.

The lenticular bottom glass 512A and lenticular top glass 512B include conductive surfaces, such as indium tin oxide (ITO), on sides of the lenticular bottom glass 512A and lenticular top glass 512B facing the switchable lens layer 513. The conductive surfaces can be configured in a pattern to configure geometry of the lenticular lens. When voltage is applied to the switchable lens layer 513, creating an electric field, directions of the liquid crystals change, which changes the index of refraction of portions of the switchable lens layer 513. The changing of the index of refraction of portions of the switchable lens layer 513 creates a lensing effect, switching the lenticular display 500 from a two-dimensional display to a three-dimensional display.

In some implementations, the switchable lens layer 513 of FIG. 5 operates in a first state for a two-dimensional display mode and in a second state for a three-dimensional display mode. In the first state, a reduced voltage or no voltage can be applied across the switchable lens layer 513 so that the switchable lens layer 513 has a reduced lensing effect. In the second state, a voltage can be applied across the switchable lens layer 513 to establish an electric field that changes orientations of liquid crystals in the switchable lens layer 513 and thereby forms a lenticular optical profile. The applied voltage can be uniform across the switchable lens layer 513 or can vary across electrode regions to define a selected lens geometry. In some embodiments, touch sensing by the first touch sensor layer 506A and the second touch sensor layer 506B is time-multiplexed with lens driving of the switchable lens layer 513 so that touch detection and lens switching can be performed with reduced electrical interference.

In some implementations, a plurality of switchable lenses are provided in the lenticular stack. For example, a first switchable lens can be disposed on a first side of a liquid crystal layer and a second switchable lens can be disposed on a second side of the liquid crystal layer. The first switchable lens and the second switchable lens can be driven together or independently to modify an optical profile of the lenticular stack for switching between a two-dimensional display mode and a three-dimensional display mode.

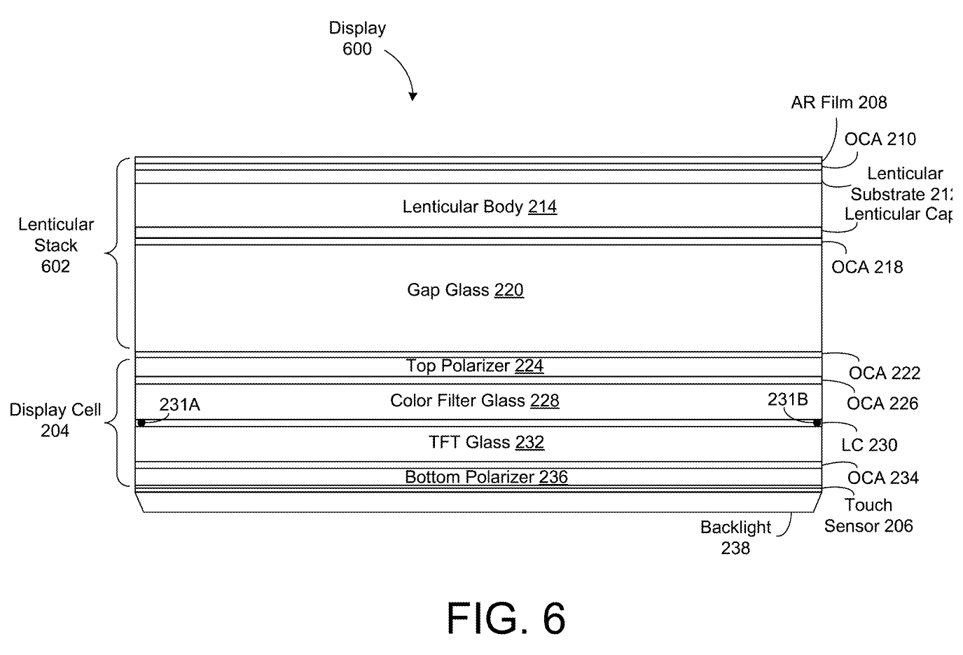

FIG. 6 is another example of a lenticular display 600 with a touch sensor 206. In this example, the touch sensor 206 is between the display cell 204 and the backlight 238. In this example, a lenticular stack 602 has similar features as the lenticular stack 202 shown and described with respect to FIG. 2.

In some implementations, the arrangement of FIG. 6 is applied to a display architecture in which the touch sensor 206 is positioned on a side of the display cell 204 opposite the lenticular stack 602. For example, where the display cell 204 is implemented as a liquid crystal display including the bottom polarizer 236 and the backlight 238, the touch sensor 206 can be disposed between the display cell 204 and the backlight 238 so that the touch sensor 206 is farther from the lenticular stack 602 than in the arrangement of FIG. 2. Such an arrangement can be selected based on manufacturing considerations, integration with an existing display module, or routing of touch-sensor conductors. In some implementations, the touch sensor 206 is optically coupled to an adjacent surface by an optically-clear adhesive so as to reduce internal reflections and preserve brightness.

FIG. 7 is an example of the touch sensor 206. The first touch sensor layer 706A has nodes arrayed in a first direction. The second touch sensor layer 706C has nodes arrayed in a second direction that is perpendicular or orthogonal to the direction in which the nodes of the first touch sensor layer 706A are arrayed from a top or bottom perspective that sees only the first touch sensor layer 706A or the second touch sensor layer 706C. The nodes of both the first touch sensor layer 706A and the second touch sensor layer 706C are arrayed in a direction parallel to each other and to the substrate 706B from a cross-sectional perspective that sees all three of the first touch sensor layer 706A, the substrate 706B, and the second touch sensor layer 706C. The substrate 706B is between the first touch sensor layer 706A and the second touch sensor layer 706C. In some implementations, the nodes of the first touch sensor layer 706A and the second touch sensor layer 706C are resistive nodes. In some implementations, the nodes of the first touch sensor layer 706A and the second touch sensor layer 706C are capacitive nodes. The resistance or capacitance (or impedance) of the nodes of the first touch sensor layer 706A and the second touch sensor layer 706C changes in response to contact with and/or proximity of a body part, such as a finger, of the user 152. The computing device 154 can determine the location of the body part based on the changed resistance or capacitance.

In some implementations, each of the first touch sensor layer 706A and the second touch sensor layer 706C includes a transparent conductive material patterned as sensing electrodes, routing traces, and peripheral bus lines. The transparent conductive material can include indium tin oxide, metal mesh, conductive polymer, graphene, or another transparent conductor. The substrate 706B can be considered a touch sensor substrate that includes an internal dielectric layer that provides mechanical support and electrical isolation between the first touch sensor layer 706A and the second touch sensor layer 706C. The substrate 706B can include glass, polyethylene terephthalate, polyethylene naphthalate, polycarbonate, or another dielectric sheet that provides mechanical support and electrical isolation between the first touch sensor layer 706A and the second touch sensor layer 706C. The sensing electrodes can be arranged as rows and columns that overlap in different directions to define touch-sensitive intersections. In some implementations, a peripheral region of the touch sensor 206 includes conductive pads coupled to a controller of the computing device 154 so that the controller can scan the sensing electrodes and determine a touch location.

In some implementations, the touch sensor 206 operates according to a mutual-capacitance sensing mode, a self-capacitance sensing mode, a resistive sensing mode, or a combination thereof. In a mutual-capacitance sensing mode, a drive signal is applied to electrodes of one touch sensor layer and a response is detected on electrodes of the other touch sensor layer. A touch event by a finger or stylus changes a local electric field and changes a detected capacitance at one or more intersections, from which the controller can determine a touch coordinate. In a resistive sensing mode, contact pressure changes resistance between conductive features so that a touch coordinate can be determined from measured voltages or currents. In some embodiments, the controller applies filtering, interpolation, baseline correction, or time averaging to reduce noise and to improve coordinate accuracy. The controller can further detect gesture input including tap, swipe, multi-touch, or press-and-hold input.

In some implementations, electrical routing for the touch sensor 206 is positioned in a peripheral border region outside an active display area of the display cell 204. This arrangement can reduce obstruction of light within the active display area while permitting connection of the touch sensor 206 to controller circuitry. Shield traces or grounding structures can be provided adjacent to selected routing traces to reduce parasitic coupling. In some implementations, the touch sensor 206 is synchronized with display updating and backlight driving so that sensing operations occur during intervals that reduce visible artifacts or electrical noise.

In some implementations, a controller of the computing device 154 coordinates operation of the display cell 204, the touch sensor 206, and, where present, the switchable lens layer 513. The controller can drive image data to the display cell 204, scan one or more touch sensor layers to detect touch input, and/or selectively apply lens-control signals to change between a two-dimensional mode and a three-dimensional mode. In some implementations, the controller performs these operations according to a timing sequence that reduces electrical interference and maintains image quality and touch-detection accuracy.

FIG. 8 shows an example of a screen 856 and lenticular lens 854 that can be included in a lenticular display. Examples of the lenticular display are the lenticular display 100, lenticular display 200, lenticular display 300, lenticular display 400, lenticular display 500, and lenticular display 600. The screen 856 can have features and/or properties of the display cell 204. The lenticular lens 854 is an example of the lenticular lens described above. The lenticular lens 854 can refract light intended for a left eye 852A in a first direction and light intended for a right eye 852B in a second direction. The user 152 will then receive light forming different images in each of the left eye 852A and right eye 852B, which causes the user 152 to interpret a three-dimensional image.

In some implementations, the screen 856 displays image information arranged as interleaved view data corresponding to different viewing directions. The lenticular lens 854 directs a first portion of the image information toward the left eye 852A and directs a second portion of the image information toward the right eye 852B. The image information can be organized at a pixel level, sub-pixel level, column level, or group level so that different portions of the displayed image are visible from different viewing positions. In this manner, the screen 856 and lenticular lens 854 cooperate to present different views of a scene to the left eye 852A and the right eye 852B.

In some implementations, the lenticular display can be assembled as separate subassemblies before final lamination. For example, the display cell 204 can be assembled as a first subassembly, the touch sensor 206 can be assembled as a second subassembly, and the lenticular stack 202 can be assembled as a third subassembly, after which the subassemblies are laminated together. In some implementations, one or more of the touch sensor layers are formed directly on an adjacent glass or polymer layer by deposition and patterning of transparent conductive material. The disclosed arrangements permit the touch sensor 206 to be positioned at different depths within the lenticular display while still maintaining a relatively short optical distance between the touch sensor 206 and the display cell 204 compared with arrangements in which a touch sensor is positioned farther from the display cell 204.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special-purpose logic circuitry, e.g., an FPGA (field programmable gate array) or an ASIC (application-specific integrated circuit).

Processors suitable for the execution of a computer program include, by way of example, both general and special-purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special-purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the true spirit of the disclosed embodiments.

What is claimed is:

1. An apparatus comprising:
a display cell;
a lenticular lens;
a first touch sensor layer disposed between the display cell and a substrate; and
a second touch sensor layer, the substrate disposed between the first touch sensor layer and the second touch sensor layer, the second touch sensor layer disposed between the substrate and the lenticular lens.

2. The apparatus of claim 1, wherein the display cell comprises:
a first polarizer;
a second polarizer; and
a glass substrate between the first polarizer and the second polarizer.

3. The apparatus of claim 1, further comprising a glass layer between the second touch sensor layer and the lenticular lens.

4. The apparatus of claim 1, further comprising a glass layer between the first touch sensor layer and the display cell.

5. The apparatus of claim 1, wherein the substrate is a dielectric substrate.

6. The apparatus of claim 1, wherein the display cell comprises a liquid crystal display.

7. The apparatus of claim 6, wherein the display cell comprises a thin-film transistor glass layer, a color filter glass, and a liquid crystal layer between the thin-film transistor glass layer and the color filter glass.

8. The apparatus of claim 7, wherein the display cell further comprises a top polarizer between the color filter glass and the first touch sensor layer.

9. The apparatus of claim 1, further comprising an optically-clear adhesive between the display cell and the first touch sensor layer.

10. The apparatus of claim 1, wherein the lenticular lens comprises a lenticular cap, a lenticular body, and a lenticular substrate.

11. The apparatus of claim 10, wherein the lenticular cap has a lower index of refraction than the lenticular body.

12. An apparatus comprising:
a display cell;
a first lenticular glass layer;
a substrate disposed between the display cell and the first lenticular glass layer;
the first lenticular glass layer disposed between the substrate and a first touch sensor layer;
the first touch sensor layer disposed between the first lenticular glass layer and a liquid crystal layer;
the liquid crystal layer disposed between the first touch sensor layer and a second touch sensor layer;
the second touch sensor layer between the liquid crystal layer and a second lenticular glass layer; and
the second lenticular glass layer.

13. The apparatus of claim 12, wherein the substrate comprises a glass layer.

14. The apparatus of claim 12, further comprising:
a first switchable lens between the first touch sensor layer and the liquid crystal layer; and
a second switchable lens between the liquid crystal layer and the second touch sensor layer.

15. The apparatus of claim 12, wherein the liquid crystal layer is configurable in a first state having a reduced lensing effect for a two-dimensional display mode and in a second state having a lenticular optical profile for a three-dimensional display mode.

16. The apparatus of claim 12, wherein the substrate is a dielectric substrate.

17. An apparatus comprising:
a first touch sensor layer;
a substrate disposed between the first touch sensor layer and a second touch sensor layer;
the second touch sensor layer disposed between the substrate and a display cell;
the display cell disposed between the second touch sensor layer and a lenticular stack; and
the lenticular stack.

18. The apparatus of claim 17, further comprising a glass layer between the display cell and the lenticular stack.

19. The apparatus of claim 17, wherein the lenticular stack comprises a gap glass and a lenticular lens, the gap glass being between the second touch sensor layer and the lenticular lens.

20. The apparatus of claim 17, wherein the first touch sensor layer and the second touch sensor layer comprise capacitive nodes.
